(19) United States
(12) Patent Application Publication
(10) Pub. No.: US 2005/0071806 A1
(43) Pub. Date: Mar. 31, 2005

(54) Variational modeling using extension types

(75) Inventor: Vugranam C. Sreedhar, White Plains, NY (US)

Correspondence Address: FERENCE & ASSOCIATES, 400 BROAD STREET, PITTSBURGH, PA, 15143, US

(73) Assignee: IBM Corporation, Armonk, NY (US)

(21) Appl. No.: 10/676,952

(22) Filed: Sep. 30, 2003

(51) Int. Cl. G06F 9/44

(52) U.S. Cl. 717/104

(57) ABSTRACT

The use of extension types as a mechanism for an essentially horizontal extension of types for modeling multiple extensions and variations of a software artifact. In that an extension type is a tuple of unrelated classes, each element class in the tuple corresponds to an extension of the extension type. Using extension types, one can bring two unrelated classes or types together to perform computations. Shown herein are manners via which extension types may elegantly model multiple and dynamic extensions of an artifact. Also shown is how extension types simplify aspect-oriented software development and several design patterns.

### FIELD OF THE INVENTION

The present invention relates generally to the modeling of software artifacts and to various problems and issues encountered in connection therewith.

### BACKGROUND OF THE INVENTION

A list of references is set forth at the close of the present disclosure; individual references from the list are referred to herebelow numerically (i.e., [1], [2], [3], etc . . . ).

One of the goals in a free-form interactive surface modeling is to let a user control the shape of the surface design. One way to achieve this is to search for the right representation as controls for direct manipulation by the user. For instance, in control mesh approach, “pushing” or “pulling” a control point makes local “bumps” and “dents” whose shape is relatively easy to control. But local bumps and dents tend not to be the only types of features that a user might want to create. A conceptually simple change can be frustrating since one may have to reposition many, if not all, control points to achieve the desired result. In surface modeling this kind of problem arises whenever controls provided to user are closely tied the representation's degree of freedom, since no fixed set of controls can be expected to anticipate all of the users' needs. [15]

The situation described above is not unique to surface modeling. Software engineering discipline faces similar problems. When modeling software engineering artifacts, a user can often be frustrated because control points provided to the user are closely tied to the representations' degree of freedom. In this vein, one may consider object-oriented (OO) design methodology for software development. An OO language, such as Java or C++, provides a user with a few control points for manipulating software artifacts. Inheritance lets a user extend a class. In that class extensions tend not to represent the only type of controls that a user wants, it is often very difficult, if not impossible, to make a simple change, such as adding logging feature to a set of classes. [14]. Accordingly, a need has been recognized in connection with providing a user with an infinitely malleable software artifact having no fixed structure or controls of its own. To this software artifact additional features or control points can then be added to obtain concrete controllable software artifacts.

One way to model variation and extension (“variation modeling”) of a software artifact is to sever the link between controls (e.g., sub-typing) and representations (e.g., sub-classing). Indeed, the separation of concerns as a way to model software variations is discussed in [10] and [14]. In particular, aspect-oriented software development (AOSD) is one way to realize the separation of concerns. [14]. However, the current AOSD methodologies are quite far from achieving a complete separation of control from representation.

In view of the foregoing, a need has been recognized in connection with overcoming the shortcomings and deficiencies presented by known arrangements.

### SUMMARY OF THE INVENTION

There is broadly contemplated herein the use of extension types for modeling multiple extensions and variations of a software artifact. An extension type is a tuple of element types or classes, each of which corresponds to an extension or a variation of the type. Class extension via sub-classing (i.e., class hierarchy) extends classes (types) “vertically”. In vertical class extensions, a sub-class can masquerade any of its super-classes. Extension types compose classes “horizontally”, and an extension type can masquerade any of its elements types.

In summary, one aspect of the invention provides an apparatus for modeling at least one aspect of a software artifact, said apparatus comprising an arrangement for providing extension types, each extension type comprising an ordered tuple of a plurality of element types, each of the element types corresponding to different class hierarchies.

Another aspect of the present invention provides a method of modeling at least one aspect of a software artifact, said method comprising the step of providing extension types, each extension type comprising an ordered tuple of a plurality of element types, each of the element types corresponding to different class hierarchies.

Furthermore, an additional aspect of the invention provides a program storage device readable by machine, tangibly embodying a program of instructions executable by the machine to perform method steps for modeling at least one aspect of a software artifact, said method comprising the step of providing extension types, each extension type comprising an ordered tuple of a plurality of element types, each of the element types corresponding to different class hierarchies.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 schematically illustrates a class hierarchy of employees in a company.

FIG. 2 schematically illustrates a relationship between an extension type and its elements.

FIG. 3 schematically illustrates a personnel class hierarchy.

FIG. 3a schematically illustrates an employee class.

FIG. 4 schematically illustrates a payroll class hierarchy.

FIG. 5 schematically illustrates a revised employee class hierarchy.

FIG. 6 schematically illustrates the parameterization of a support element type hierarchy with respect to a principal element type hierarchy.

FIG. 7 schematically illustrates the structure of a classical “Observer” pattern.

FIG. 8 schematically illustrates an arrangement whereby extension type decouples control and representation.

FIG. 9 schematically illustrates the structure of “State Pattern”.

### DESCRIPTION OF THE PREFERRED EMBODIMENTS

In connection with developing extension types, one may consider the Decorator pattern. [4] A Decorator pattern allows one to attach additional responsibilities to an object. Consider a Display class that contains a paint( ) method for painting graphical objects. A display object
Display d=new Display ( )
   can be decorated using DecoratedDisplay class
DecoratedDisplay dd=new DecoratedDisplay(d)

DecoratedDisplay is an enhanced Display that contains an enhanced paint( ) method. A call to d.paint( ) is then re-factored to dd.paint( ), to get the effect of the new paint method.

HyperJ (see below) provides a simpler solution for Decorator pattern using a composition rule similar to the following:
override(Display, (DecoratedDisplay, Display))

This essentially merges the two classes (the old Display and DecoratedDisplay) into one class. The new class is still called Display and it contains all functionality of the two classes. A method such as paint( ) will be picked up from DecoratedDisplay in the new Display class. The HyperJ approach is completely non-invasive; it does not touch any of the client code. But a disadvantage of HyperJ approach is that every client will get the new Display. One way to deal with this is to use a new name for Display:
override(NewDisplay, (DecoratedDisplay, Display))

Consider now invasively changing references to Display to NewDisplay. However, this now creates a new class NewDisplay, which is not semantically related to the old classes; only the code from the old classes is explicitly copied into the new class.

In contrast, there is broadly contemplated in accordance with at least one presently preferred embodiment of the present invention the composition of Display and DecoratedDisplay to create a new type, herein referred to as an “extension type”, without explicitly creating a new class:
(DecoratedDisplay,Display) ed;
ed=new(DecoratedDisplay, Display);

The DecoratedDisplay class contains the enhanced paint method, and so a call to ed.paint( ) will invoke the new paint( ) method, overriding the old method paint( ) in Display. Now if one wants to invoke the old paint( ) method, then on can do so in an extension type using the syntax ed(1).paint( ). Extension types are ordered tuples, and so one can access elements of a tuple via indexing. The extension type (DecoratedDisplay,Display) is a sub-type of both Display and DecoratedDisplay types, and therefore can masquerade the two element types. Unlike the HyperJ approach, one does not create any new classes. Also, the extension type composition is at instance-level rather than at class-level. Therefore, users that do not care about the DecoratedDisplay need not extend their Display object.

Herein there is also described the semantics of extension types, and several applications of extension types are given in the context of aspect-oriented software development and design patterns. There is introduced the notion of parameterized extension types that provide more type-safe composition than is possible with pure extension types. There are also presented manners of modeling both multiple classification and dynamic classification using extension types (see [9]). (Particularly, whereas [9] is an early article showing multiple/dynamic classification, it hard-codes the methodology rather than use a more flexible system as contemplated herein). Finally, it will be shown how extension types can added to an AspectJ framework to provide a notion sub-typing to classes and aspects (see [6]). (Particularly, [6] represents an early paper introducing AspectJ. While aspects in AspectJ are not first class types, it will be demonstrated herein that by using extension types, aspects can be configured as first class types.)

Variational modeling is a technique for capturing variations and extensions among software artifacts. One can characterize variational modeling along two dimensions: (1) multiple variational modeling and (2) dynamic variational modeling. Multiple variational modeling deals with extensions such as multiple views of a software artifact. For instance, a person could be an employee or a spouse or a citizen, depending on the observer. Dynamic variational modeling deals with extensions such as an evolution of a software artifact and dynamic changes to a software artifact. For instance, a user may be interested in adding a new feature to a legacy artifact, or an attribute to an artifact may not be true anymore. Concepts such as multiple classifications fall under the category of multiple variational and dynamic classification falls under the category of dynamic variational modeling. [9].

Separation of concerns (SOC), a term introduced by Djisktra, refers to a software engineering concept for identifying, encapsulating, and manipulating different features (aspects, concerns, etc) of software artifacts so that one can organize and decompose software into manageable and comprehensible parts. [13][14]. A class in OO languages is one kind of a concern. There are others kinds of concern that can cut across multiple classes, such as logging, printing, persistence, and display capabilities. HyperJ and AspectJ™ are two different implementations of SOC in Java [13][6].

HyperJ uses concepts such as hyperslice and hyperspace. [13] A hyperspace is a “space of concerns” that is spanned by a set of “vectors of concerns”. A set of “vector of concerns” is called a hyperslice of a hyperspace. A “basis concern” for a hyperspace is an independent set of concerns that span the hyperspace. A dimension of a hyperspace H is the number of elements (concerns) in a basis concern for H. A hypermodule M is a sub-hyperspace of a hyperspace H that consists of hyperslices along with operations for composing hyperslices. Hypermodules are building blocks, and are not, in general, complete, executable programs. A system is a hypermodule that is complete, and can therefore run independently. OO languages such as Java and C++ support what is termed as a “tyranny of dominant decomposition,” or separation and encapsulation along only one dominant hyperslice. [13][14]. For instance, consider the class hierarchy of employees in a company as shown in FIG. 1. As shown, the class hierarchy contains at least two hyperslices that are tangled: (1) personnel hyperslice including employee name, identity, management hierarchy, etc., and (2) payroll hyperslice including salary, tax, and other related information. There is a poor separation of concerns in such a class design. One way to separate the personnel concern from payroll concern is to create two class hierarchies: one for personnel department and another for payroll department. An Employee class hierarchy can then be constructed by appropriately composing the two hyperslices. HyperJ, for instance, proposes a set of composition operations on hyperslices. An interesting aspect of the HyperJ approach is that composition operations are separate from hyperslices. This allows one to construct new class hierarchies in a non-intrusive manner.

Accordingly, let H₁, H₂, . . . , Hₙ be a set of hyperslices. Let CH be a new class hierarchy that was constructed by composing H₁, H₂, . . . , Hₙ using a set of composition operations O. With this in mind, a disadvantage of the HyperJ approach is that a new class hierarchy is created for every new set of operations on H₁, H₂, . . . , Hₙ; the new class hierarchy CH has no semantic relation to H₁, H₂, . . . , Hₙ. For instance, a class in CH need not be a sub-type of a class in any H₁, H₂, . . . , Hₙ. In HyperJ, hyperslice composition happens at compilation/loading time, creating new classes. HyperJ does not support the notion of “instance” or “object” level composition of hyperslices. Due to these limitations HyperJ does not support dynamic variational modeling, such as, for instance, a research employee decides to become a sales executive.

AspectJ™ is a general-purpose aspect-oriented programming (AOP) extension to Java. [6] In AspectJ, “aspects” modularize concerns that affect one or more classes. AspectJ uses the notion of “join points” to insert new behavior in existing code. Join points are well-defined points in the execution of a program, which includes, reading or writing a field; calling or executing an exception handler, method or constructor. These join points are described by the “pointcut” declaration. Pointcuts are typically defined in aspects. An “advice” is a piece of code that is executed at each join point defined in a pointcut. There are three kinds of advice: before advice, around advice and after advice. Pointcuts and advice are encapsulated in an aspect. An “aspect” is like a class that encapsulates pointcuts and advices. An aspect can also include methods and field and can extend another class or aspect.

One cannot create instances of aspects or type program variables as aspect types in AspectJ. In other words, aspects are not first-class types in AspectJ. Also, there is no notion of sub-type relation among aspects, although one aspect can extend another aspect. The semantics of aspect inheritance is not same as for classes. When one aspect extends another aspect it does not override pointcuts or advices defined in the parent aspect. In AspectJ, first the child pointcut is executed and then the parent pointcut is executed. For instance, one may consider the Observer pattern (see also supra). [4] The following is a code snippet of the Notify aspect:

```
aspect Notify {
  declare parents: Employee extends Subject ;
    pointcut stateChange (Subject s):
      call (void Employee.age( ))
    after(Subject s) : stateChange(s) {
        s.nofity( )
    }
}
```

In the above example, it is declared that Employee extends Subject. The pointcut statechange specifies that Employee.age( ) to be the joinpoint. The advice statement essentially invokes s.notify( ) after each execution of Employee.age( ).

Now one can compile the above aspect with Employee class:
ajc Employee.java Notify.java

The compiler generates byte code that contains Employee class with the new Subject behavior.

Both the AspectJ and HyperJ approaches go beyond traditional OO concepts. The basic premise for both approaches is that modularity goes well beyond what can be expressed in traditional OO languages. Similar patterns of code fragments occur in many places (e.g. logging code fragment). AspectJ achieves modularity by collecting all similar patterns into a single aspect, and provides rules for injecting those patterns into other classes as and when needed. Code injection happens at compilation time. HyperJ also follows a similar approach, but treats similar code patterns as a separate hyperslice and provides rules for composing hyperslices. Once again, hyperslice composition happens at compilation time. In order to make AspectJ more fluid or HyperJ more morphogenic, one needs to go beyond compile time compositions. [22] One needs to treat aspects in AspectJ as first-class types, as well as hyperslice in HyperJ. Once one treats aspects and hyperslices as first-class types, one can then compose them dynamically as needed. Also, once one treats them as first-class types one can apply standard type analysis to ensure type-safe composition. Extension types are one way to achieve the above goals. In extension types, one can treat hyperslices and aspects as first-class types and by treating them as first-class types one increases the expressiveness of both AspectJ and HyperJ approaches.

The notion of extension type, as contemplated herein, arises at least partly from the observation that compilation time class-level composition limits the expressiveness of variational modeling. Typically, in class-based languages, the class hierarchy structure determines sub-type relation among types. A class hierarchy is either a tree (single inheritance) or an acyclic graph (multiple inheritance). If A is a class (type) that is ancestor of another class B in the class hierarchy then B is a subtype of A, and is denoted as B<:A. Consider a variable p whose declared type is A. Then at run-time, p can point to any object o whose type is B. Here the object o of type B has all the “capabilities” of an object of type A (and so type B can masquerade as an object of type A). So when a method p.m is invoked through p, the method m is guaranteed to be executed by the object o.

Class-based languages, such as Java and C++, provide a one-dimensional view of a class hierarchy; that is, two classes are related (through sub-class relation) only if one of them is an ancestor of the other in the class hierarchy. The control point (i.e., the sub-type relation) is closely tied to the representation (i.e., the class hierarchy). The close tie between sub-type relation and class hierarchy has been debated elsewhere in other contexts (this will be treated later). HyperJ goes one step further and views a class hierarchy as one hyperslice and provides composition operations to compose several such hyperslices to create a new class hierarchy that somehow captures all the features of the individual hyperslices. What is missing in HyperJ is the semantic relation (i.e., control points) between the new class and the old hyperslices. Rather than explicitly create a new class for every set of composition operation and (possibly) discard the old hyperslices, a new composed type (extension type) is now contemplated which establishes a sub-type relation between the new type and its constituent types.

As a first-order extension type, an extension type a is an ordered tuple of simple types or classes (it will be appreciated herethroughout that ordering is important for defining subtype relations). For instance,
(A, B, C, D) p
   indicates that the type of the variable p is an extension type and the extension type includes at most four element types or classes. Each of the four element types may belong to different class hierarchies. In other words, there may not be any explicit sub-type relations among the four element types. Although elements of an extension type can itself be another extension type (higher-order extension types), herethroughout the elements of an extension type will be understood as being restricted to be of simple types (i.e., first-order extension types). The size or dimension of the extension type, denoted as lal, is the number of elements in the extension type. One can access the elements of an extension type via indexing, e.g., α(0), α(1), etc.

Accordingly, let α and β be two extension types. One can define a sub-type relation α<:β as follows:
   |α|>=|β|, the size of α is greater than or equal to the size of β.
α(0)<:β(0), α(1)<:β(1), . . . α(|β|−1)<:β(|β|−1), each element type of α(i) is a sub-type (sub-class) of the corresponding element type of β(i) (up to the size of β).

An extension type α is always a subtype of its element types, that is, α<:α(0), α<: α(1), etc. One can use “typedef” syntactic sugar to explicitly name extension types; thus:
typedef (A, B,C) X
   indicates that X is a new type name for (A,B,C).

With regard to method dispatch, let P be the declared type of p and Q be the run-time type of an object o pointed by p. A method lookup p.m( ) in Java involves walking up the class hierarchy from Q and finding the closest implementation of m. In an extension type one can define different kinds of method dispatches. Let α be the extension type of a variable p and let β be the runtime extension type of the object pointed by p, so that β<:α. With this in mind:

1. p.m method dispatch is very similar to the traditional dispatch, except that one may look for m in all element class hierarchies. One preferably starts at the element type β(0) and walks up the class hierarchy of β(0) to find the closest m. If m is not defined in the class hierarchy of β(0), one then looks for m in β(1) class hierarchy. This process is repeated for each |β| class hierarchies of β and find the first m and dispatch the method m. Notice that the method m should be declared in at least one element class of α. The method dispatch p.m( ) is like the “override” rule in HyperJ.

2. p*m method dispatch is defined as follows: For each element type β(i), in the order i=0, . . . , |β|−1, walk up the class hierarchy of β(i) to find the closest m in β(i) and dispatch the method m (if found). It is a type error if m is not defined in at least one of βi=0, . . . , |β|−1, class hierarchies. Notice that in this case one may invoke at most |β| methods. The method m should be declared in at least one element class of α. The method dispatch p*m( ) is motivated by the correspondence rule “merge-by-name” in HyperJ.

3. p(1,3,4).m is exactly the same as p.m, except that one only looks at a class hierarchy of β(1), β(3), and β(4). It is a type error if m is not defined in any of β(1), β(3), or β(4).

4. p(1,3,4)*m is exactly the same as p*m, except that one only looks at a class hierarchy of β(1), β(3), and β(4). It is a type error if m is not defined in any of the class hierarchies to which β(1), β(3), or β(4) belongs.

One may note that in the method dispatch p.m only one method body is executed, whereas in p*m, one can have at most |β|−1 method bodies executed. If the return type of m is not void, then p*m can return |β|−1 values. Consider the following example:
(A,B,C) p=new (A,B,C,D)
(x, y, z)=p*m( );

The return value of p(A).m is stored in x, of p(B).m is stored in y, and of p(C) is stored in z. The type of (x,y,z) is sometimes called as tuple type (e.g., Eiffel and ML). If the method m is not defined in a class hierarchy, say, class hierarchy of B, the value of the variable y is unchanged.

The method dispatch p.m( ) is like the override rule in HyperJ. The method dispatch p*m( ) is motivated by correspondence rule “merge-by-name” in HyperJ. This rule allows one to combine methods from different hyperslices into one method in the new composed hyperslice. A call to the new method will in turn invoke each of the old method. One can define other kinds of dispatch mechanisms that can handle other kinds of HyperJ composition rules.

One can create new extension objects as follows:
(X,Y,Z) p=new (X,Y,Z)

In this case p points to an object of extension type (X,Y,Z). One can create extension object incrementally as follows:
(X,Y,Z) p=new (X, , Z)

A method call p(Y).m will give rise to null pointer exception. Later one can create the Y-element object as follows:
p(1).new(Y)

Notice that p(1 ).new(Y)) is not the same as p=new(,Y,). In the former case one dynamically updates the object pointed to by p, and in the latter case p points to a new object, which contains two holes (at indices p(0) and p(2)). The above dynamic update allows one to model dynamic variational modeling or dynamic classification.

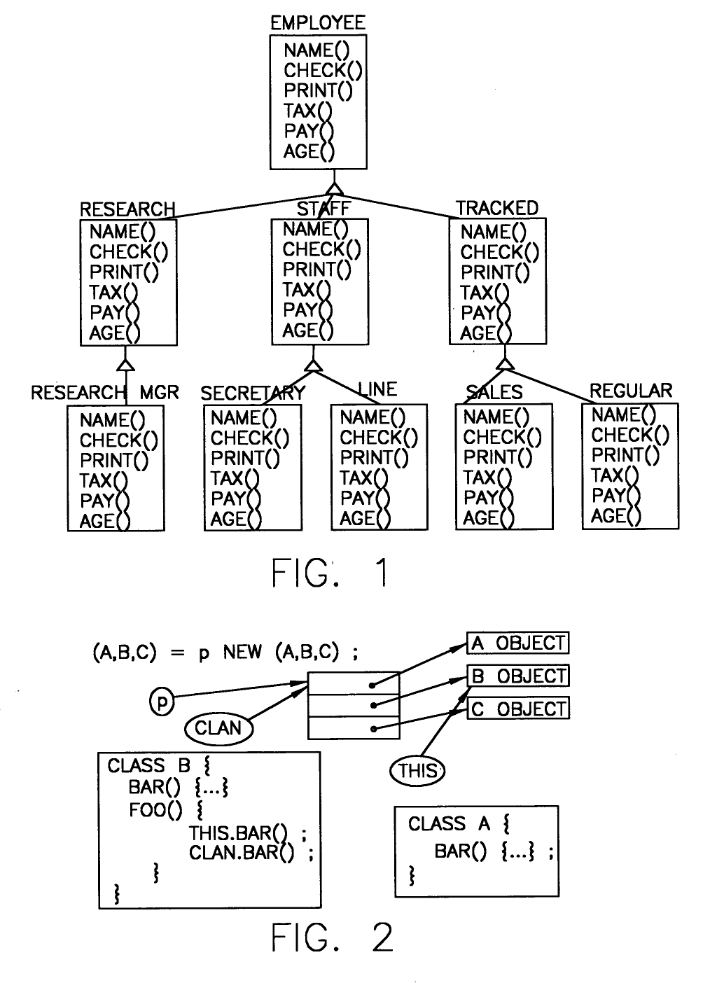

It is important to remember that each element type in an extension type may belong to different independently developed class hierarchies. The notion of this and super types is applicable to within a class hierarchy and not across class hierarchies. The keyword this denotes the current object. The keyword “super” denotes the super type of the current element object type. The keyword clan represents the extension type object to which the current object belongs to. A method dispatch clan.m is similar to the method dispatch discussed earlier for extension type; one starts at the element type clan(0) and walks up the class hierarchy to find the closest m. If m is not defined in clan(0) class hierarchy, one then looks for m in clan(1), and repeat the process. If the current object is not an element of any extension type then clan object is same as the this object. The relationship between an extension type and its elements is illustrated in FIG. 2. Also shown are clan and this object references.

A simple element object can belong to at most one extension object at any instance. In other words, a simple object cannot be shared among multiple extension objects. This restriction is necessary to ensure consistency among extension objects. For instance, if an object belongs to more than one extension object, then a clan call clan.foo( ) can be very confusing, and one cannot type the clan reference.

Generally, extension types are not same as array of objects or list of objects. Unlike in arrays or lists, the elements of an extension can be totally unrelated with each other. Also, an array or list is not a subtype of its elements. An element class in an extension type can be abstract and yet one can create instances of the element type (which includes instances of abstract element classes).

HyperJ provides several kinds of composition rules. Herein there are only discussed “override” and “merge-by-name” correspondence rules. It is possible to encode other rules at the time when extension objects are created. For instance, consider the following two classes:
class A { . . . ; void m( ) { . . . } . . . }
class B { . . . ; void n( ) { . . . } . . . }

One may create an extension type
typedef (A,B) p;

Now assume that one wants to ensure that method m( ) and n( ) are same, that is, the “equate” rule in HyperJ. One can do this at the time when extension object is created.
p=new (A,B) {equate A.m, B.n};

A method dispatch p.n( ) is then the same as p.m( ). (There has not yet been explored other rules in HyperJ that can be encoded in extension types.)

The disclosure now turns to how extension types can be used in AOSD. First, the HyperJ approach will be focused upon, and thence the AspectJ approach.

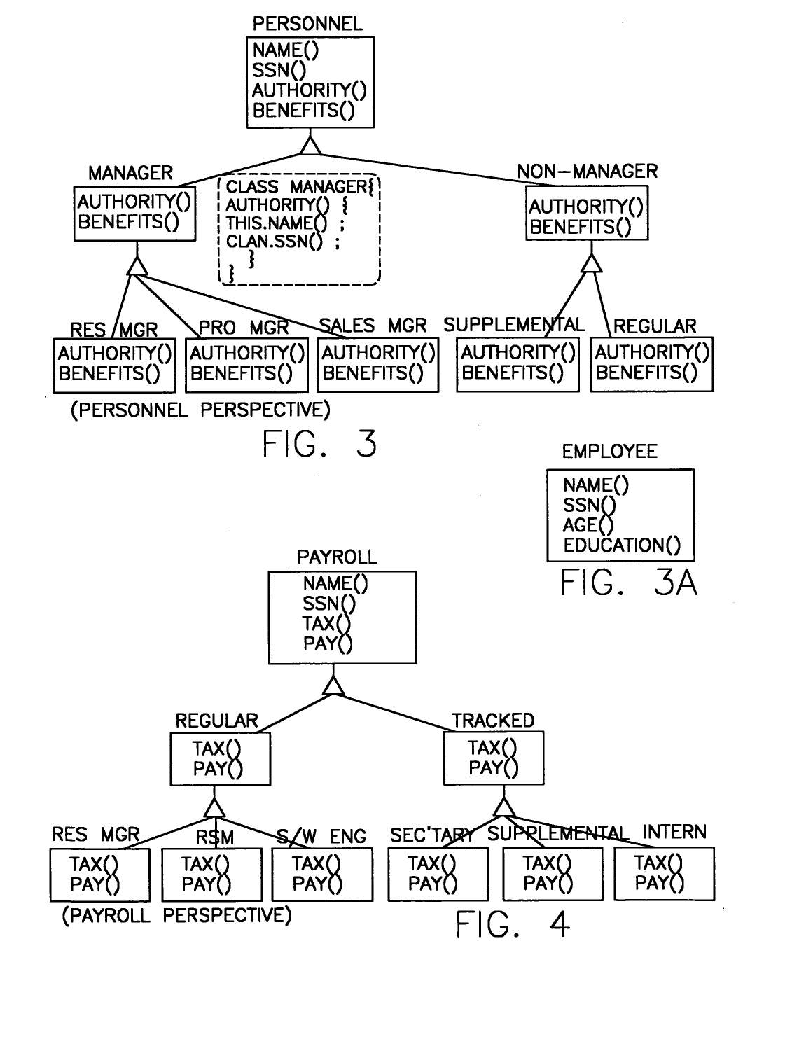

FIGS. 3, 3a and 4 illustrate the three independently developed class hierarchies, each of them in different packages or modules: (1) employee class (FIG. 3a), (2) payroll class hierarchy (FIG. 3) and (3) personnel class hierarchy (FIG. 4). The payroll class hierarchy keeps track of pay, tax, and other pay related features, including business rules and tax regulations. Presumably, the payroll department will not care about benefits and authority. The personnel class contains features related to benefits and management hierarchy; here, it can be presumed that the personnel department will not care about payroll information. Within payroll class hierarchy, methods like pay( ) and tax( ) may access employee name and social security number (ssn). Both name( ) and ssn( ) are declared as abstract in both personnel and payroll class hierarchy. In FIG. 3, abstract methods are italicized. The employee class contains personal information of an employee including name, ssn, age, etc.

When an employee record is created the record should contain not only an employee's personal data, it should also contain payroll and personnel data. Using extension type one can create an employee record as follows:

```
class Driver {
  main( ) {
    (Employee, Manager, ResMgr) emp =
        new (Employee, Manager, ResMgr);
  }
}
```

It is to be noted that both Manager and ResMgr are abstract classes, and yet instances of them were created. This is fine as long as there is at least one implementation of an abstract method within the elements of the extension type. For instance, the element provides implementation for the two abstract methods name( ) and ssn( ) declared in the other two elements of the extension type. The statement
(Manager, ResMgr) blah=new (Manager, ResMgr)
   will trigger a type error, since the abstract methods defined in Manager and ResMgr have no implementations. The type system will check for at least one concrete implementation of ssn( ) when the class Manager is used as an element within an extension type (as explained above).

Now one can invoke the method emp.benefits( ) to determine the benefits of an employee. The business rules of personnel department are in a separate class hierarchy from that of the business rules of the payroll department. The two class hierarchies, personnel and payroll, can evolve independently without impacting others. Unlike HyperJ, one need not create any new (composed) class hierarchy, and yet the benefits of separation of concern are still obtained. In HyperJ one may create a large number of new classes to accommodate different combinations of compositions.

Extension types are different from multiple inheritance. If one were to use multiple inheritances, one would have to create a new class that inherits from all three class hierarchies, in order to create an employee record. Once again one may create a large number of new classes to accommodate different combination of business rules from personnel and payroll departments. For instance, EmployeeManagerResManager could be a new class that inherits from the three classes: Employee, Manager, and ResMgr.

Turning to AspectJ and extension types, AspectJ (as described in [6]) supports what Kiczales refers to as static AOP [22]. In [6], the aspects and classes are relatively fixed or static in that changing them involves editing the program. Fluid AOP will allow the easy remodularization of both aspects and classes. This dynamic remodularization is related to dynamic classification.

One way to make AOP more fluid is to consider aspects as types, or rather as type decorators. Consider the Observer pattern example discussed hereinabove. Accordingly, one may declare an extension type as follows:
(Employee, Notify) es=new (Employee,Notify)

Here, the aspect Notify is treated like a type decorator. One can create an aspect object instance and attach it to the Employee class object instance. The pointcut and advice defined in the aspect Notify is applied to the current instance of Employee class. The type (Employee, Notify) is a sub-type of Employee, and so one can substitute Employee type by (Employee,Notify).

Now one can extend the Notify aspect (similar to what is done in AspectJ) to create a new aspect:
aspect NewNotify extends Notify { . . . }

The new aspect NewNotify is sub-type of Notify. Now one can dynamically re-modularize the es extension object instance so that it now has the new aspect:
es.new(,NewNotify);

This dynamical aspect change supports Kiczales fluid AOP. A method dispatch such as es.age( ) should be appropriately compiled so that the pointcut and advice rules defined in Notify aspect is also handled.

One may note that the extension type (Employee, Notify) contains both Employee class and Notify aspects. In the context of AspectJ one can define an “aspect extension type” to include both classes and aspects as elements. In general, an aspect extension type can be defined as follows:
(C¹₁, C¹₂, . . . , A¹₁, A¹₂, . . . , C²₁, C²₂, . . . , A²₁, A²₂, . . . )

The aspects A¹₁, A¹₂, . . . are only applied to classes C¹₁, C¹₂, . . . Similarly the aspects A²₁, A²₂, . . . are only applied to classes C²₁, C²₂, . . . Aspect extension types decorate extension types to contain new behavior.

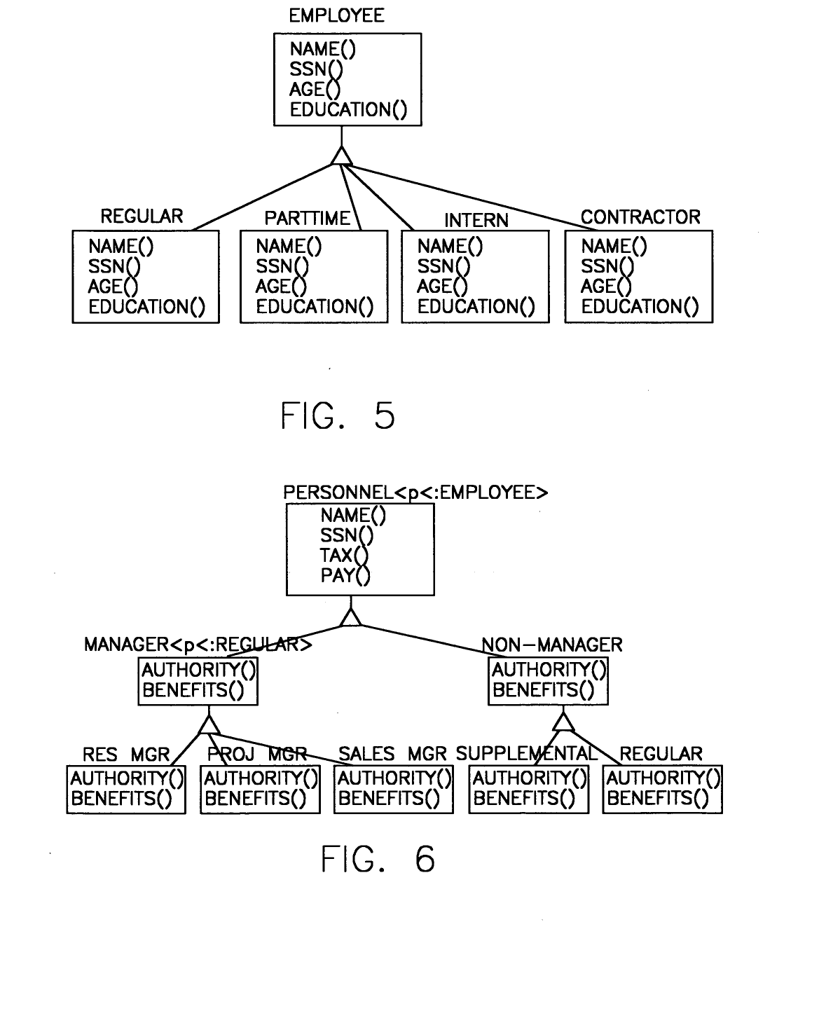

The disclosure now turns to parameterized extension types. Generally, extension types as contemplated herein allow one to mix and match features from different independently developed class hierarchies. But one may often want to restrict (from the type system point of view) how different features are mixed and matched. Consider the employee class discussed earlier. One may extend this class to include different classes of employees: regular, contractors, part-time, and interns. Such a new employee class hierarchy is shown in FIG. 5.

Assume that the Personnel Department wants to restrict the Manager position only to Regular employees. In other words, only a regular employee can be a manager. One can use parameterized extension types for achieving this.

Particularly, parameterized extension types utilize the concept of “principal element type”. For the present purposes, the first component of an extension type may be called the principal element type. For the following declaration:
(Employee, Personnel, Payroll) p
   Employee is designated the “principal element type”, whereas Personnel and Payroll are designated “support element types”. In some sense, Personnel and Payroll add “extra features” to, or extend, the principal type Employee. One may parameterize the support element type hierarchy with respect to the principal element type hierarchy, as shown in FIG. 6.

The construct Personnel<p<: Employee> indicates that the type Personnel can be an element of an extension type whose principal element is a subtype of Employee. A sub-type of Personnel can further restrict p. For instance, the Manager type is restricted to only Regular types. When constructing an extension type, the type system will perform appropriate type checking taking into account the restrictions on the parameters. For example,
(Regular, Manager) v;
is a valid extension type. On the other hand
(Employee, Manager) iv;
is not a valid extension, since the Manager feature cannot be applied to all employees but only to a sub-type of Regular employees. It is to be noted that the way the type parameter p is used to further restrict sub-type relation is similar to virtual typing[11] The concept of principal element type hierarchy is related to principal dimension or hyperslice in HyperJ. [13]

The disclosure now turns to a brief description of how extension types can help simplify many design patterns. [4]

A Visitor pattern allows one to add a new operation to a class hierarchy without modifying the classes in the class hierarchy. Traditionally, in languages like Java, a Visitor pattern is implemented using a double-dispatch mechanism. Using HyperJ or AspectJ, one can avoid such a double-dispatch mechanism. Herebelow, it will be shown that by using parameterized extension type one can implement a type-safe Visitor pattern using a single dispatch mechanism.

Consider the employee class hierarchy discussed in the previous sections. Let it be assumed that one wants to add operations in the Personnel and Payroll class hierarchies. One preferably first constructs an extension type that contains Employee and Visitor classes:
(Employee, Visitor) ev=new (Employee, Visitor);
   where Visitor is a super-type to both Personnel class and Payroll class, and it is assumed that Personnel and Payroll are two kinds of visitors for the Employee class. One can create an instance of the visitor as follows:
ev(1).new (Personnel.Manager);

One can now invoke ex.benefits( ) operation on the Manager class. Now assume that one wants to find out the tax information for the Manager:
ev(1 r).new(PayRoll.ResMgr)

One can now invoke ex.tax( ) (the method tax( ) is defined in the Payroll class hierarchy). One may now use parameterized virtual typing discussed previously to ensure type safe addition of operations.

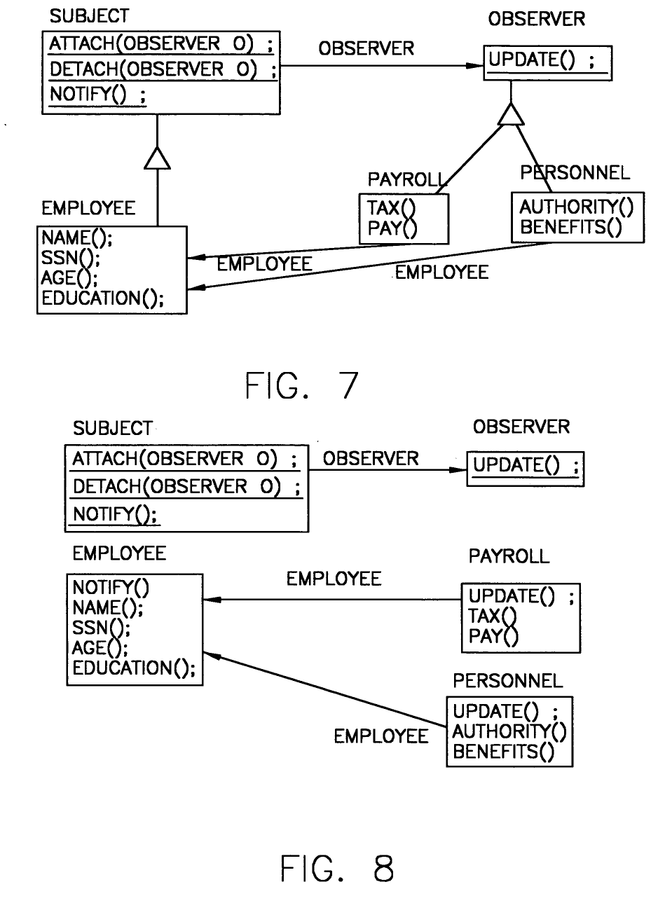

The Observer pattern allows one to define a one-to-many dependency between objects so that when one object changes state all its dependents are notified of the state update. An Observer pattern preferably has two parts: a Subject and one or more Observers. Consider the employee class discussed earlier. Let it be assumed that whenever the age of an employee changes (which happens every year), one needs to inform both the payroll department and the personnel department. Both Payroll and Personnel uses an employee's age in their business rules. Accordingly, FIG. 7 illustrates the structure of the classical Observer pattern. [4]

Whenever the age of a person changes, one preferably invokes the notify( ) method. So far as the Employee class is concerned, it really does not matter how the methods in the Subject class are implemented. Now, because of inheritance, there has been tied the Employee class to the Subject class, i.e., Employee is a subtype type of Subject. But intuitively this is not true. The only method that Employee uses from Subject is the notify( ) method, and just for this usage one is forced to make Employee a sub-type of Subject. The situation is also true in the case of the Observer class—both Payroll and Personnel class are forced to be sub-type of Observer because of one method (this will be further addressed herebelow).

It can now be seen how extension type decouples control and representation. The first step is to decouple Employee class from Subject class, and also to decouple Payroll and Personnel classes from the Observer class. The new class diagram is illustrated in FIG. 8 (where italicized methods in the figure are abstract methods). The following program illustrates how to use the different classes:
(Employee, Subject) empSub=new (Employee,Subject)
(Payroll,Observer) payObs=new (Payroll, Observer);
empSub.attach(payObs)

When there is change in the age of an employee, one preferably invokes clan.notify( ) in the Employee class. Note that notify( ) method is abstract in Employee. The update( ) method is implemented in the Subject class, and this method in turn invokes the update( ) of Payroll class. Notice that (Payroll,Observer) is a sub-type of Observer, and so payobs can be passed to the attach( ) method defined in Subject.

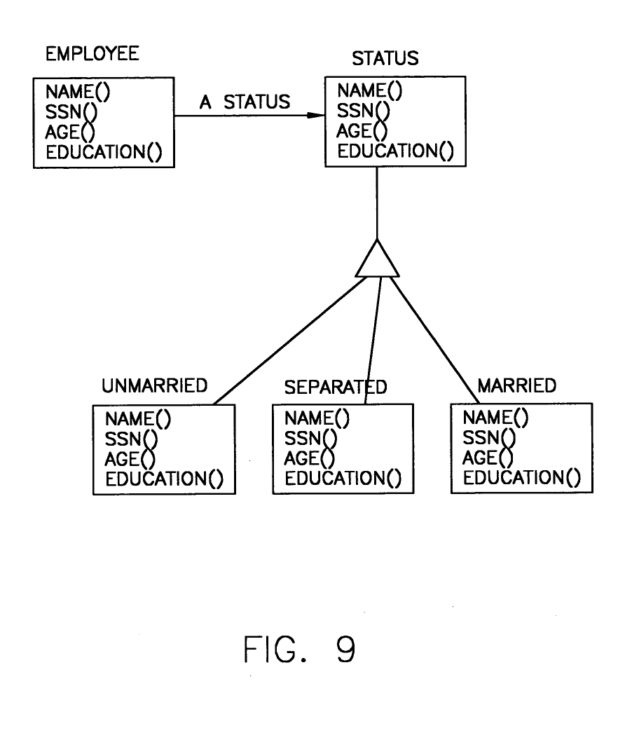

State Pattern allows an object to change its behavior whenever it changes the internal state. This way, the object will appear to change its class. Consider the status of an employee—an employee can be married, unmarried, or separated. A State Pattern includes two participants: a context that defines the interface of interest to clients and a state that defines an interface for encapsulating the behavior associated with a particular state of the context. In the present example, an employee is the context, and an employee's status is the state. FIG. 9 illustrates the structure of the State Pattern.

Note that employee status is like a role or a concern of an employee. Using our approach one simply creates an extension type:
(Employee, Status) es=new (Employee, Unmarried)

Dynamically the status of an employee can change. For instance, status of an employee can change from Unmarried to Married. One can do this as follows:
es(1 ).new(Married);

Notice that the Employee class is not aware of the Status class, and the Employee class does not hold a reference to Status object. This decoupling between Employee class and Status class is important since an employee can be made to have other new concerns or roles, for instance, project responsibilities. In this case, one may have to re-factor the Employee to hold references to the new role. In the present case, one may simply create the following extension types:
(Employee, Status, Project) esp;

The disclosure now turns to a discussion of the Wing-Liskov principle in the context of at least one embodiment of the present invention.

Wing and Liskov introduced the notion of behavioral substitutability: If S is a subtype of T, then wherever the system expects a value or object of type T, a value or object of type S can be substituted. [2] It has been debated elsewhere that sub-classing does not automatically imply sub-typing. Wing-Liskov Principle (WLP) focuses on a specific behavioral notion of substitutability, i.e., inheritance versus sub-typing. From a software design point of view, it is also important to think in terms of conceptual notion of substitutability that exists in Artificial Intelligence and other Conceptual Reasoning domain. For instance, is square a kind of a polygon? Let it be assumed that one has a program that uses polygon objects; then, using WLP, one should be able to use square objects wherever there is a polygon object. To do this, one needs to capture the relevant properties of polygon and square, including behavioral properties. But from geometry it is known conceptually that a square indeed is a kind of a polygon.

Consider the Observer pattern discussed earlier. In languages like Java that do not support multiple inheritance of classes, Employee will be a sub-class (i.e., sub-type) of the class Subject. But conceptually it is known that Employee is not a Subject. In other words, there is no conceptual relation between the Employee class and the Subject class. The Employee class really does not care about attach( ) and detach( ) method, and it only requires the notify( ) method (not even how the notify( ) method is actually implemented).

Now consider the extension type (Employee, Subject). This type does indeed behave both as an Employee and as a Subject. There is no sub-typing relation between Employee and Subject, but the extension type is a sub-type of both its elements.

Some related work will now be briefly discussed, along with significant differences presented by the embodiments of the present invention in comparison therewith.

Variational modeling is closely related to variability in software product line (SPL). [10] A SPL capture cornmonality among software product in a product family so that developers can focus on differences rather than on similarities in a product family. Variational modeling or variability can be used to model variations among software products in a product family.

Multiple and dynamic classification (MDC) is a special case of multiple and dynamic variational modeling. MDC mainly focuses characterizing data models, for instance, a person could be a customer or a spouse depending on the context. Most business data need some form of MDC mechanism. [9][7] Business enterprise is a typical information modeling application that heavily relies on variational modeling. [7] An object or an entity in an enterprise (e.g., people, project, etc.) takes on multiple and dynamic roles. For instance, a person can be an employee, a customer, both an employee and a customer, or neither. In essence a person can play several roles within an enterprise. Also, a person's role can change dynamically over a period of time. For instance, the marital status of a person can change from being unmarried to being married and/or vice-versa. Fowler discusses several ways to implement multiple/dynamic roles, including their limitations. [19]

Odell explores MDC as an extension to OO design. [9] Odell focuses on MDC from the perspective of object modeling. Odell uses object slicing as a way to implement MDC. In object slicing, an object can be “sliced” into multiple pieces and each piece is distributed across various classes of the object. Odell does not focus on AOSD concepts, linguistic mechanism, and type substitutability.

Ferret is a business process modeling language that also supports MDC. [3]. In Ferret business data is classified into classes and aspects. Classes are used for classifying data: employee, person, customer, etc. A class can be categorized into a disjoint set of aspects: Person.gender is either a male or a female. Using a combination of classes and aspects, Ferret supports MDC. Extension types as contemplated herein also support MDC but in a different way; standard class hierarchy is used for characterizing MDC. Given an extension type α=(A,B,C, . . . ), the different elements in α contribute to multiple classification. In a presently contemplated approach one can dynamically substitute an object of an element x with another object whose type is a sub-type of x (e.g., α(1).new (B)).

Multiple class inheritance is a way to implement multiple roles, but it tends to increase the number of new classes exponentially and also it hard codes roles forcing entangled roles in the class structure. State Pattern is another way to implement multiple/dynamic roles, but it requires an upfront setting up of the pattern. State Pattern solution is similar to delegation-based composition, where roles are delegated to inner classes.

Mixin is another related concept for modeling extensions. [5][17] A mixin is an abstract sub-type that may be applied to many different super-types to create a related family of modified types. A mixin acts as a “decorator” to different types without being tightly coupled to any particular type. Mixin layer in GenVoca is an extension to the basic mixin. In mixin layer a class is decomposed into a set of orthogonal roles and each role embodies separate aspect of a class. Collaboration among multiple classes is created by mixing different roles from different classes. The approaches discussed herein in accordance with at least one embodiment of the present invention are related to the mixin layer, [17]the extension types are akin to mixin composition. In a mixin layer one has to carefully design a layered class structure in order to compose mixins. Also, a mixin layer does not establish any typing relation between a class and its roles (e.g., a class is a sub-type of its roles). A role cannot exist outside its class, and so is closely coupled to a class. In an approach in accordance with at least one embodiment of the present invention, one does not explicitly represent a role. Different elements of an extension type correspond to different roles of the extension type.

Harrison and Ossher introduce group-object where a set of objects have single identity. [18]. A group-object is created by composition of primitive objects, and a group-object simply calls methods of primitive objects as defined by the composition operation. The composition operations are similar to those used in HyperJ, but performed at object level. A group-object behaves like a method combination dispatcher determining how the composed behavior of each method call is to be realized in terms of the primitive methods supplied by the group members. Group-object design was motivated by a need to model collaboration of objects rather than create a single kind of objects as is done in HyperJ (and other AOSD technique). Harrison and Ossher focus on call dispatch mechanism to model object collaboration. Harrison and Ossher do not provide any typing relation between a group-object and its primitive objects. An extension type is a kind of group-object, but our focus is on composing at type-level and also on modeling type-level AOSD. Also, our method dispatch semantics is different from that of group-object dispatch mechanism. Lea also proposes a mechanism for grouping related set of objects. [24]. He also focuses on method dispatch mechanism and proposes an alternative channel-based dispatch mechanism.

Mezini and Ostermann use concepts of family polymorphism in Caesar. [20]. Their main goal is to extend AspectJ approach to allow a more flexible reuse and componentization of aspects. Family polymorphism allows one to group a set of classes to participate in collaboration. [21]. Interestingly one can use virtual types to provide a type safe family extension. Extension types are related to family polymorphism; the set of elements in an extension type belong to the same family type. Unlike Caesar or other similar approaches one can mix and match elements to create family types on-the-fly. On the other hand family classes are statically created in Caesar. Also, the semantics of Caesar family class is quite different compared to the semantics of extension types.

Tuple types in languages like Eiffel and ML essentially are used to group a set of values or instances. In other words, tuple types act as heterogeneous containers for related set of objects and values, e.g. parameter list. Unlike extension types, tuple types are not used for dispatching methods nor is there a sub-type relation between a tuple type and its elements.

Extension type is related to intersection type and union type. [1] An intersection type a∩b is a type that contains all elements of a that are also elements of b. Our extension type contains all elements of both a and b, and in some sense behaves more like union type or variant records. The difference lies in the fact that the only operation that can be applied to a union type a∪b is one that makes sense to both a and b. In intersection type a∩b is a sub-type of both a and b (and this is not true for the union type). Extension types contemplated herein in accordance with at least one embodiment of the present invention also have this sub-type property.

In recapitulation, there have been introduced herein extension types for variational modeling. It has been demonstrated how extension types help simplify many concepts in AOSD and design patterns. Extension types is a simple way to implement multiple and dynamic classifications. Future steps could involve providing static and dynamic semantics for extension types, and to implement extension types in Java.

It is to be understood that the present invention, in accordance with at least one presently preferred embodiment, includes an arrangement for providing extension types, which may be implemented on at least one general-purpose computer running suitable software programs. It may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

### LIST OF REFERENCES

[1] B. Pierce (1992), Intersection types and bounded polymorphism, Technical Report ECS-LFCS-92-200, University of Edinburgh, LFCS.
[2] B. Liskov and J. Wing. “A Behavioral Notion of Subtyping”, ACM Transactions on Programming Languages and Systems, 16(6): 1811-1841, November 1994.
[3] B. Bloom, P. Keyser, I. Simmonds, and M. Wegman Ferret: Programming Language Support for Multiple Dynamic Classification. IBM internal report
[4] E Gamma, R Helm, R Johnson and J Vlissides, Design Patterns: Elements of Reusable Object-Oriented Software, Addison-Wesley, 1995.
[5] G Bracha and W Cook, ‘Mixin-based inheritance’, Proc. 5th ACM Conf. Object-Oriented Prog. Sys., Lang. and Appl. and Proc. 4th European Conf. Object-Oriented Prog., pub. ACM Sigplan Notices, 25(10), 303-311, 1990.
[6] G. Kiczales, J. Lamping, A. Mendhekar, C. Maeda, C. Videira Lopes, J-M Loingtier, J. Irwin. Aspect-Oriented Programming. In proceedings of the European Conference on Object-Oriented Programming (ECOOP), Finland. Springer-Verlag LNCS 1241. June 1997.
[7] H. Kilov, Generic Information Modeling Concepts: A Reusable Component Library, In Proceedings of Technology of Object-Oriented Languages and Systems (TOOLS 4), editors Jean Bezivin, Bertrand Meyer, Prentice-Hall 1991.
[8] http:H/www.research.ibm.com/hyperspace/HyperJ/HyperJ.htm
[9] J. Odell, Dynamic and Multiple Classification, Chapter 12 of Object-Oriented Behavioral Specifications, Haim Kilov, William Harvey editors, Kluwer Academic Press, 1996.
[10]J. Bosch, Design & Use of Software Architectures: Adopting and evolving a product line approach, Addison-Wesley, May 2000.
[11] K. Thorup, Genericity in Java with virtual types. In European Conference on Object-Oriented Progranmming, pages 444-471, 1997.
[12] H. Kilov and J. Ross, Information Modeling: An Object-Oriented Approach, Prentice Hall, 1994.
[13]P. Tarr, H. Ossher, W. Harrison, S. Sutton Jr., “N Degrees of Separation: Multi-Dimensional Separation of Concerns. in Proceedings of ICSE'99, 1999, ACM Press, pp. 107-119.
[14] Special section on Aspect-Oriented Programming, Communications of the ACM October 2001
[15]W. Welch and A Witkins, Variational Surface Modeling Computer Graphics (Proc. SIGGRAPH '92) Graphics, Vol. 26, 1992.
[16]W. Harrison and H. Ossher, Subject-Oriented Programming—A Critique of Pure Objects, Proceedings of 1993 Conference on Object-Oriented Programming Systems, Languages, and Applications, September 1993.
[17]Y. Smaragdakis and D. Batory, “Implementing Layered Designs with Mixin Layers”, in Proceedings of the ECOOP'98 Conference, July 1998, Springer-Verlag LNCS 1445, pp. 550-570.
[18]W. Harrison and H. Ossher Member-Group Relations Among Objects, IBM Internal report, 2002.
[19]M. Fowler. Dealing with roles. http://www.martinfowler.com/apsupp/roles.pdf, July 1997.
[20]M. Mezini and K.Ostermann. Conquering Aspects with Caesar. To appear in Proceedings of the 2nd International Conference on Aspect-Oriented Software Development (AOSD), Mar. 17-21, 2003, Boston, USA.
[21]E. Ernst. Family Polymorphism. In Proceedings ECOOP 2001, LNCS 2072, pages 303-326, Budapest, Hungary, June 2001. Springer-Verlag.
[22]G. Kiczales, “Aspect-Oriented Programming: The Fun Has Just Begun,” Software Design and Productivity Coordinating Group Workshop on New Visions for Software Design and Productivity: Research and Applications, Nashville, Tenn., December 2001.
[23] D. Syme and A. Kennedy, “Design and Implementation of Generics for the .NET Common Language Runtime,” PLDI 2001, Snowbird, Utah, 2001.
[24] D. Lea http://gee.cs.oswego.edu/dl/papers/groups.pdf

1. An apparatus for modeling at least one aspect of a software artifact, said apparatus comprising an arrangement for providing extension types, each extension type comprising an ordered tuple of a plurality of element types, each of the element types corresponding to different class hierarchies.

2. The apparatus according to claim 1, wherein each extension type comprises an extension or variation of element types.

3. The apparatus according to claim 1, wherein said extension types are adapted to compose classes horizontally.

4. The apparatus according to claim 1, wherein each extension type is adapted to masquerade as any associated element type.

5. The apparatus according to claim 1, wherein each extension type is a subtype of its associated element types.

6. The apparatus according to claim 1, wherein:
each extension type has a size corresponding to the number of elements associated with the extension type; and
given two extension types α and β, a sub-type relation α<: β is definable as follows:

|α|>=|β|; and
α(0)<: β(0), α(1)<: β(1), . . . α(|β|−1)<: β(|β|−1).

7. The apparatus according to claim 1, wherein, with a being the extension type of a variable p and β being the runtime extension type of the object pointed by p, so that β<:α:
a method dispatch p.m comprises starting at the element type β(0) and walking up the class hierarchy of β(0) to find the closest m, wherein if m is not defined in the class hierarchy of β(0), then m is sought in the β(1) class hierarchy and, if needed, in one or more iteratively successive class hierarchies, until found.

8. The apparatus according to claim 1, wherein, with a being the extension type of a variable p and β being the runtime extension type of the object pointed by p, so that β<:α:
a method dispatch p*m comprises, for each element type β(i), in the order i=0, . . . , |β|−1, walking up the class hierarchy of β(i) to find the closest m in β(i) and dispatching the method m (if found), whereby a type error arises if m is not defined in at least one of the class hierarchies β(i), i=0, . . . , |β|−1.

9. The apparatus according to claim 1, wherein, with ax being the extension type of a variable p and β being the runtime extension type of the object pointed by p, so that β<:α:
a method dispatch p(1,3,4).m comprises reviewing only a class hierarchy of β(1), β(3), and β(4)to find the closest m, wherein a type error arises if m is not defined in any of β(1), β(3), or β(4).

10. The apparatus according to claim 1, wherein, with α being the extension type of a variable p and β being the runtime extension type of the object pointed by p, so that β<:α:
a method dispatch p(1,3,4)*m comprises reviewing only a class hierarchy of β(1), β(3), and β(4)to find the closest m in β(i) and dispatching the method m if found, whereby a type error arises if in any of the class hierarchies to which β(1), β(3), or β(4) belongs m is not defined.

11. A method of modeling at least one aspect of a software artifact, said method comprising the step of providing extension types, each extension type comprising an ordered tuple of a plurality of element types, each of the element types corresponding to different class hierarchies.

12. The method according to claim 11, wherein each extension type comprises an extension or variation of element types.

13. The method according to claim 11, wherein the extension types are adapted to compose classes horizontally.

14. The method according to claim 11, wherein each extension type is adapted to masquerade as any associated element type.

15. The method according to claim 11, wherein each extension type is a subtype of its associated element types.

16. The method according to claim 11, wherein:
each extension type has a size corresponding to the number of elements associated with the extension type; and
given two extension types α and β, a sub-type relation α<:β is definable as follows:

|α|>=|β|; and
α(0)<: β(0), α(1)<: β(1), . . . α(|β|−1)<:β(|β|−1).

17. The method according to claim 11, wherein, with a being the extension type of a variable p and β being the runtime extension type of the object pointed by p, so that β<:α:
a method dispatch p.m comprises starting at the element type β(0) and walking up the class hierarchy of β(0) to find the closest m, wherein if m is not defined in the class hierarchy of β(0), then m is sought in the β(1) class hierarchy and, if needed, in one or more iteratively successive class hierarchies, until found.

18. The method according to claim 11, wherein, with cc being the extension type of a variable p and β being the runtime extension type of the object pointed by p, so that β<:α:
a method dispatch p*m comprises, for each element type β(i), in the order i=0, . . . , |β|−1, walking up the class hierarchy of β(i) to find the closest m in β(i) and dispatching the method m (if found), whereby a type error arises if m is not defined in at least one of the class hierarchies β(i), i=0, . . . , |β|−1.

19. The method according to claim 11, wherein, with a being the extension type of a variable p and β being the runtime extension type of the object pointed by p, so that β<:α:
a method dispatch p(1,3,4).m comprises reviewing only a class hierarchy of β(1), β(3), and β(4)to find the closest m, wherein a type error arises if m is not defined in any of β(1), β(3), or β(4).

20. The method according to claim 11, wherein, with a being the extension type of a variable p and β being the runtime extension type of the object pointed by p, so that β<:α:
a method dispatch p(1,3,4)*m comprises reviewing only a class hierarchy of β(1), β(3), and β(4)to find the closest m in β(i) and dispatching the method m if found, whereby a type error arises if in any of the class hierarchies to which β(1), β(3), or β(4) belongs m is not defined.

21. A program storage device readable by machine, tangibly embodying a program of instructions executable by the machine to perform method steps for modeling at least one aspect of a software artifact, said method comprising the step of providing extension types, each extension type comprising an ordered tuple of a plurality of element types, each of the element types corresponding to different class hierarchies.
